(19) United States
(12) Patent Application Publication
(10) Pub. No.: US 2025/0371259 A1
(43) Pub. Date: Dec. 4, 2025

(54) SYSTEMS AND METHODS FOR TEMPLATE GENERATION AND RISK-BASED MATCHING FOR ELECTRONIC MESSAGES

(71) Applicant: OPTUM, INC., Minnetonka, MN (US)

(72) Inventors: Ziqian Huang, Buffalo Grove, IL (US); Justina M Zou, Raleigh, NC (US); Jenna M. Very, Plymouth, MN (US)

(21) Appl. No.: 18/678,176

(22) Filed: May 30, 2024

(51) Int. Cl. G06F 40/186; H04L 51/21

(52) U.S. Cl. CPC G06F 40/186; H04L 51/21

(57) ABSTRACT

A system is configured to generate a plurality of electronic message templates by applying a generative machine learning model to electronic message feature data. The system generates a plurality of susceptibility metrics using a predictive ML model, wherein each susceptibility metric indicates a predicted probability of a respective individual, of a plurality of individuals, interacting with an electronic message generated using a respective electronic message template of the plurality of electronic message templates. For each individual, the system may select a particular electronic message template based at least upon the susceptibility metric associated with the individual and the particular electronic message template, generate a respective electronic message based upon the particular electronic message template, and cause the respective electronic message to be provided to a user device of the individual.

### TECHNICAL FIELD

The present disclosure generally relates to fraudulent electronic messages, and more particularly, to systems and methods for generating and directing/routing automated test messages that are specific to particular individuals.

### BACKGROUND

Users of electronic messaging systems (e.g., email or text messaging systems) are vulnerable to social engineering attacks, such as phishing, carried out using fraudulent electronic messages. Advancements in artificial intelligence, including generative artificial intelligence, allow bad actors to craft more convincing messages of this sort, increasing the risk of the message recipient falling victim to such attacks. For organizations of all types (e.g., corporations, firms, universities, etc.), it is important to defend against such attacks, for various purposes (e.g., safeguarding against security breaches wherein customer and/or employee information is accessed). One of the best ways of defending against these attacks is to raise the awareness of individuals within an organization. To this end, many organizations implement social engineering awareness training programs. However, these training programs lose effectiveness when unable to match the rapid advancement, sophistication, and trends of social engineering attacks.

Moreover, conventional techniques for social engineering awareness training tend to take a generalized approach, e.g., with the same test phishing email being broadly distributed among a particular population (employees, etc.). This can be ineffective because different people are susceptible to different types of phishing attacks and/or phishing content. For example, one person may be susceptible to phishing emails that provide the hint of a financial benefit, while another may be highly skeptical of such emails but susceptible to phishing emails that evoke the reader's sympathies. Thus, to fully test whether a large number of individuals would interact with a fraudulent message, conventional approaches must either create and distribute a large number of electronic messages to all of the individuals, which is time-consuming to those generating the messages, wasteful of network resources, and distracting to the recipients. Alternatively, the organization runs the risk of failing to probe the weaknesses/susceptibilities of some of its members (employees, etc.), which may be unacceptable given that even a single security breach can be highly problematic.

Accordingly, there is a need for improved social engineering awareness training. More specifically, to enable this improvement, there is a need for systems and methods that can automatically generate electronic messages that effectively probe/test the recipients' particular susceptibilities, and can link or route such messages to the appropriate recipients.

### SUMMARY

The present embodiments relate to, inter alia, systems and methods for template generation and risk-based matching for electronic messages.

In one aspect, a computer-implemented method includes (i) generating, by one or more processors, a plurality of electronic message templates, at least by applying a generative machine learning (ML) model, trained on a corpus of electronic messages, to electronic message feature data indicating electronic message features; (ii) generating, by the one or more processors, a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and (iii) for each individual of the plurality of individuals, (a) selecting, by the one or more processors, a particular electronic message template of the plurality of electronic message templates, based at least upon the susceptibility metric associated with the individual and the particular electronic message template, (b) generating, by the one or more processors, a respective electronic message based upon the selected particular message template, and (c) causing, by the one or more processors, the respective electronic message to be provided to a user device associated with the individual.

In another aspect, a system includes memory and one or more processors communicatively coupled to the memory, the one or more processors configured to: (i) generate a plurality of electronic message templates, at least by applying a generative ML model, trained on a corpus of electronic messages, to electronic message feature data indicating electronic message features; (ii) generate a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and (iii) for each individual of the plurality of individuals, (a) select a particular electronic message template of the plurality of electronic message templates, based at least upon the susceptibility metric associated with the individual and the particular electronic message template, (b) generate a respective electronic message based upon the particular electronic message template, and (c) causing the respective electronic message to be provided to a user device associated with the individual.

In another aspect, one or more non-transitory computer-readable storage media include instructions that, when executed by one or more processors, cause the one or more processors to: (i) generate a plurality of electronic message templates, at least by applying a generative ML model, trained on a corpus of electronic messages, to electronic message feature data indicating electronic message features; (ii) generate a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and (iii) for each individual of the plurality of individuals, (a) select a particular electronic message template of the plurality of electronic message templates, based at least upon the susceptibility metric associated with the individual and the particular electronic message template, (b) generate a respective electronic message based upon the particular electronic message template, and (c) cause the respective electronic message to be provided to a user device associated with the individual.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts a block diagram of an example computing environment in which methods and systems for template generation and risk-based matching for electronic messages are implemented, according to one embodiment.

FIG. 2 depicts a block diagram of an example mobile device in which computer- implemented methods and systems for template generation and risk-based matching for electronic messages are implemented, according to one embodiment.

FIG. 3 depicts an example data flow diagram for ML model training and operation, according to one embodiment.

FIG. 4A depicts an example workflow that can be implemented by the server of FIG. 1, according to one embodiment.

FIG. 4B depicts an example electronic message template, according to one embodiment.

FIG. 5 depicts a flow diagram of an example computer-implemented method for template generation and risk-based matching for electronic messages, according to one embodiment.

### DETAILED DESCRIPTION

The computer systems and methods disclosed herein use a generative machine learning (ML) model to generate electronic message templates, in conjunction with using a predictive ML model to generate susceptibility metrics (e.g., score, rating, ranking, etc.) indicating probabilities of various individuals interacting with (e.g., responding to) electronic messages generated using particular electronic message templates. The systems and methods can then use the susceptibility metrics to select the electronic message templates that are most likely to be effective for training particular individuals (e.g., most likely to invoke responses or other interactions from the individuals), generate electronic messages based on those templates, and cause the electronic messages to be provided to devices of the corresponding individuals. The electronic messages may be emails, text messages (e.g., SMS messages), instant messages, and/or any other message that can be provided in electronic form with some mechanism for user interaction (e.g., responding with another electronic message, clicking on a link within the electronic message, etc.).

These disclosed techniques advantageously provide improvements in electronic message generation and assignment/routing technologies within computer networks. Advantageously, the use of susceptibility metrics that are both individual-specific and template- specific, when selecting an electronic message template for an individual, increases the probability of generating and directing to the individual an electronic message that effectively probes/tests the individual's particular susceptibilities (e.g., an electronic message to which the individual is more likely to respond or with which the individual is otherwise more likely to interact). Moreover, the use of these techniques in conjunction with a generative ML model to create the electronic message templates results in a highly efficient process that saves time and other resources as compared to, for example, manually creating templates. As a result, the disclosed techniques can be applied to generate many multiples (e.g., hundreds, thousands, hundreds of thousands, etc.) of electronic messages, each having features/customizations specific to the individual, and possibly also specific to other circumstances and/or entities (e.g., specific to an organization at which the individual is employed). For example, an organization can create and distribute individually tailored electronic messages to some or all of its personnel to provide improved social engineering awareness training and/or test vulnerabilities.

In some embodiments, generating the electronic message templates is based upon electronic message features relevant to social engineering as indicated by social engineering inferences/trends and social engineering topics, advantageously creating a pool of electronic message templates that is more representative of current fraudulent (e.g., phishing) efforts, adding a further level of sophistication to the electronic message templates.

Some embodiments monitor interaction of the individual with the electronic message generated using the selected template. The monitoring can indicate, for example, whether an individual responded to or otherwise interacted with (e.g., clicked on a link within) the electronic message. The results from the monitoring can be used, for example, to identify or confirm weaknesses/susceptibilities to social engineering that are unique to each individual, provide individual-specific insights into the effectiveness of social engineering awareness training, and/or increase the effectiveness of future trainings. For example, data gathered via the monitoring can be used as training data to update or retrain the disclosed ML models.

The present disclosure includes specific features other than what is well-understood, routine, conventional activity in the field, and/or otherwise adds unconventional steps that confine the disclosure to a particular useful application, e.g., efficiently generating and directing (e.g., linking or routing) electronic messages to particular individuals in a manner that effectively tests/probes the susceptibilities of those individuals. The technical improvements and advantages described herein are not the sole improvements and advantages, and other improvements and advantages may be apparent to one of ordinary skill in the art.

### Computing Environment

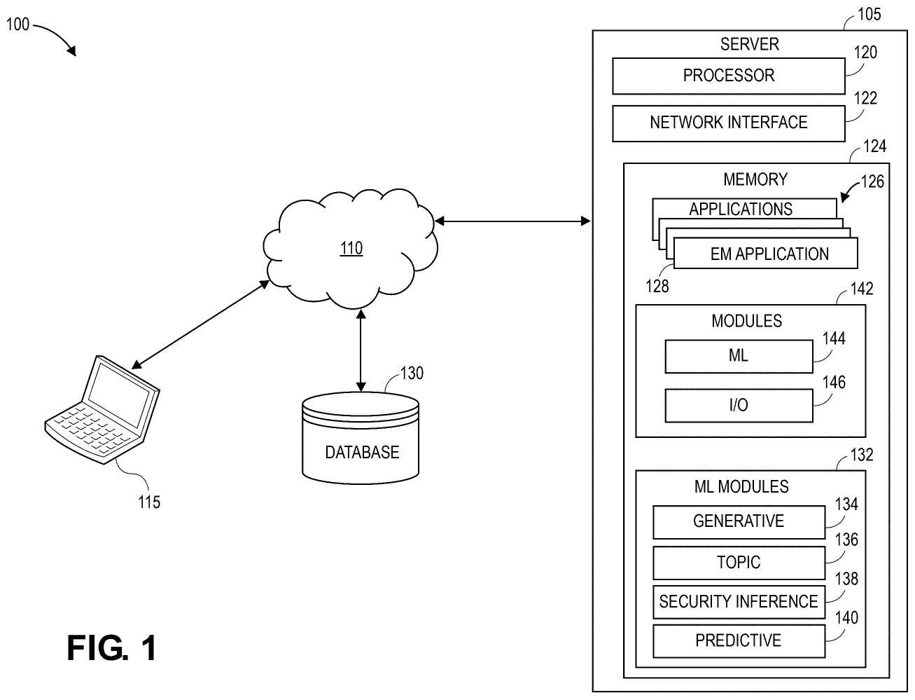

FIG. 1 depicts an example computing environment 100 in which template generation and risk-based matching techniques for electronic messages may be implemented. Although FIG. 1 depicts certain entities, components, equipment, and devices, it should be appreciated that additional or alternate entities, components, equipment, and devices are also possible.

As illustrated in FIG. 1, the computing environment 100 includes, in one embodiment, a server 105 which can perform the at least some of the functionalities and techniques disclosed herein, such as generating electronic message templates, generating susceptibility metrics, and so on. The server 105 may include only one server, or multiple servers that are co-located and/or remotely distributed. The server 105 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The example computing environment 100 includes a network 110 comprising any suitable network or combination of networks, such as a local area network (LAN), a wide area network (WAN), the Internet, or a combination thereof. For example, the network 110 may include a wireless cellular network (e.g., 4G, 5G, 6G, etc.). Generally, the network 110 enables bidirectional communication between the server 105 and/or at least one user device 115. In one embodiment, the network 110 comprises a cellular base station, such as cell tower(s), communicating to the one or more other components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, and/or other such wireless nodes communicating with the components of the computing environment 100 via wired and/or wireless communications based upon any one or more of various communications standards, including by non-limiting example, IEEE 802.11a/ac/ax/b/c/g/n (Wi-Fi), Bluetooth, and/or the like.

The example server 105 includes processor 120. The processor 120 includes one or more processors, such as central processing units (CPUs), graphics processing units (GPUs), and/or any other suitable processor. The processor 120 is communicatively coupled to a memory 124 via a computer bus (not depicted) to create, read, update, transmit, delete, or otherwise access or interact with the data, data packets, or otherwise electronic signals to and from the processor 120 and the memory 124, e.g., in order to implement or perform the machine-readable instructions, methods, processes, elements, or limitations, as illustrated, depicted, or described for the various flowcharts, illustrations, diagrams, figures, and/or other disclosure herein. The processor 120 interfaces with the memory 124 via a computer bus to execute an operating system and/or computing instructions stored in the memory 124, and/or to access other services/components/etc. For example, the processor 120 may interface with the memory 124 via the computer bus to create, read, update, delete, or otherwise access or interact with the data stored in the memory 124 and/or database 130.

The server 105 includes a network interface 122 which allows the server 105 to communicate over the network 110 (e.g., with user device 115, databases 130) via any suitable wired and/or wireless connection, e.g., using any suitable network interface controller(s) of the network interface 122. The network interface 122 may include one or more transceivers (e.g., wireless WAN (WWAN), wireless LAN (WLAN), and/or wireless personal area network (WPAN) transceivers) functioning in accordance with IEEE reference standards, 3GPP reference standards, and/or other reference standards that may be used in receipt and transmission of data via external/network ports of the server 105 connected to computer network 110.

The memory 124 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc. The memory 124 stores machine-readable instructions executable by the processor 120, including the instructions of one or more application(s) 126. The memory 124 also stores an operating system (e.g., Microsoft Windows, Linux, UNIX, etc.) capable of facilitating the functionalities, applications, methods, or other software of the applications 126 as discussed herein.

In the example embodiment of FIG. 1, the applications 126 include an electronic messaging application (“EM application”) 128. The EM application 128 provides various functionalities described in further detail below, such as generating electronic message templates, generating susceptibility metrics for individuals, selecting templates for particular individuals, generating electronic messages based on selected templates, and/or monitoring user interactions with electronic messages.

The example server 105 includes, and/or has access to (e.g., via network 110), the database 130. The database 130 may include one or more databases that are co-located or remotely distributed. The database 130 may be or include a relational database, such as Oracle, DB2, MySQL, a NoSQL based database, such as MongoDB, or another suitable database. The database 130 may store data and/or datasets discussed herein, such as electronic message templates, electronic message template characteristic data, electronic message feature data, organizational characteristic information, personnel data of an organization, historical electronic message data of the organization, training datasets used to train and/or operate one or more ML models, and so on. A dataset may include one or more types of data, records, files, etc. The terms “data” and “dataset” may be used interchangeably herein.

The memory 124 stores one or more ML models 132, discussed briefly here and in more detail below. The ML models 132 may be referred to at times herein as “models” or “algorithms.”

In some embodiments, the ML models 132 include a generative ML model 134 trained to generate electronic message templates based upon electronic message features. Generally speaking, the generative ML model 134 may be trained to receive input data, and generate as an output new content that is reflective of the input. In at least one aspect, the generative ML model 134 is trained on a corpus of electronic messages (e.g., actual and/or manually created phishing or other social engineering electronic messages and/or message templates) to receive as an input electronic message feature data indicating one or more electronic message features, and generate as an output an electronic message template that reflects or corresponds to the electronic message feature(s). In some embodiments, the generative ML model 134 includes a large language model (LLM). Alternatively or additionally, the generative ML model 134 may include a generative adversarial network, a long short-term memory (LSTM) network, or another type of seq2seq model or transformer model, or may include a Bidirectional Encoder Representations from Transformers (BERT) or Mamba model.

In some embodiments, the ML models 132 include a topic ML model 136 trained to generate at least one topic indicated in (e.g., mentioned in or reflected by) posts, such as social engineering topics. The topic ML model 136 may also generate a corresponding metric indicating the importance and/or popularity of the generated topic relative to the posts. As used herein, the term “post” may include content/text posted to a social media platform, such a Facebook posts, Twitter posts, Instagram posts, etc. In one embodiment, the topic ML model 136 is trained on historical post data of a plurality of posts (e.g., the contents of actual and/or manually created posts). In such an embodiment, the topic ML model 136 is trained to receive as an input post data associated with a plurality of posts (e.g., the content of the posts, and possibly associated metadata such as date, post type, etc.), and generate as an output topic data indicating at least one topic of the posts, e.g., a social engineering topic mentioned in or otherwise reflected by a post. In one embodiment, the server 105 generates electronic message feature data that is input to generative ML model 134 using the topic data. In one embodiment, the topic ML model 136 includes a graph ML model (e.g., to generate the importance/popularity metric). Alternatively, the topic ML model 144 may include an LLM, a latent Dirichlet allocation (LDA) model, or a K-means clustering model.

In some embodiments, the ML models 132 include a security inference ML model 138 trained to generate security inferences indicated in security intelligence information. A security inference may include a social engineering trend, or other suitable inference associated with social engineering. In one embodiment, the security inference ML model 138 is trained on historical security intelligence data. The historical security intelligence data may be indicative of historical security inferences, historical social engineering trends (e.g., past phishing trends), etc. In such an embodiment, the security inference ML model 138 is trained to receive as an input security intelligence data (e.g., the contents of recent phishing emails), and generate as an output security inference data indicating at least one security inference, e.g., a security-related inference (e.g., a type of emotional trigger increasingly used in phishing emails, a topic of recent phishing emails, etc.). In at least one aspect, the server 105 generates the electronic message feature data that is input to generative ML model 134 using the security inference data. The security inference ML model 138 may include an LLM, and may determine the trends by analyzing Common Vulnerabilities and Exposures (CVE), Common Weakness Enumeration (CWE), and/or Vulnerability Ranking information, for example.

In some embodiments, the ML models 132 include a predictive ML model 140 trained on predictive ML training data. In some such embodiments, the predictive ML model 140 is trained to receive as an input one or more of (1) information regarding one or more organizational characteristics of the individual (e.g., job title, job type, pay grade, employment division, type of business, tenure at the organization, telecommuter status, employment classification, system access level) (2) historical electronic message data indicating historical electronic message information of the organization for the individual, and/or (3) electronic message template characteristic data indicating characteristics of the plurality of electronic message templates. For a given individual-template pair (e.g., where the organizational characteristics are specific to that individual, and the electronic message template characteristic data is specific to that template), the predictive ML model 140 generates as an output a susceptibility metric indicating a predicted probability of that particular individual interacting with an electronic message generated using that particular electronic message template. In one embodiment, the predictive ML model 140 includes an XGBoost model. Alternatively, the predictive ML model 144 may include a neural network, a random forest model, a boosting model (e.g., a CatBoost model, a LightGBM, an AdaBoost model, etc.), a support vector machine, a logistic regression model, a naïve Bayes model, or an ensemble model.

The memory 124 may also store a plurality of computing modules 142, implemented as respective sets of computer-executable instructions as described herein.

In one embodiment, the computing modules 142 include an ML module 144 comprising a set of computer-executable instructions implementing ML loading, configuration, initialization, and/or operation functionality. In some embodiments, at least one of a plurality of ML methods and algorithms is applied by the ML module 144, where the ML methods and algorithms may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on the server(s) 105. For example, libraries may include the TensorFlow based library, the PyTorch library, and/or the scikit-learn Python library.

In one embodiment, the ML module 144 employs supervised learning, which involves identifying patterns in existing data to make predictions about subsequently received data. Specifically, the ML module is “trained” using training data, which includes example inputs and associated example outputs. Based upon the training data, the ML module 144 may generate a predictive function which maps outputs to inputs and may utilize the predictive function to generate ML outputs based upon data inputs. The example inputs and example outputs of the training data may include any of the data inputs or ML outputs disclosed herein. In example embodiments, a processing element is trained by providing it with a large sample of data with known characteristics or features.

In another embodiment, the ML module 144 may employ unsupervised learning, which involves finding meaningful relationships or patterns in unorganized data. Unlike supervised learning, unsupervised learning does not involve user-initiated training based upon example inputs with associated outputs. Rather, in unsupervised learning, the ML module 144 may organize unlabeled data according to a relationship determined by at least one ML method/algorithm employed by the ML module 144. Unorganized data may include any combination of data inputs and/or ML outputs as described above.

In yet another embodiment, the ML module 144 may employ reinforcement learning, which involves optimizing outputs based upon feedback from a reward signal. Specifically, the ML module 144 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 144 may receive labeled data at an input layer of a model having a networked layer architecture (e.g., an artificial neural network, a convolutional neural network, etc.) for training the one or more ML models 132. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models 132. The output layer may be trained to output a prediction, for example.

In operation, ML module 144 may access the database 130, or any other data source, for training data suitable to generate one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 144 at runtime to process input data and generate output data. As discussed, once trained, the one or more trained ML models may be operated in inference mode, whereupon when provided with de novo input that the model has not previously been provided, the model may output one or more predictions, classifications, etc., as described herein. The ML module 144 may include instructions for storing the trained ML models 132 (e.g., in the memory 124, in electronic database 130, etc.).

In various embodiments, examples, and/or aspects disclosed herein may include training and generating one or more ML models for the server 105 to load at runtime. Additionally, or alternatively, one or more appropriately trained ML models may already exist (e.g., in the database 130) such that the server 105 may load an existing trained ML model at runtime. In some implementations, server 105 may retrain, fine-tune, update and/or otherwise alter an existing ML model before and/or after loading the model at runtime.

In one aspect, the computing modules 142 include an I/O module 146, comprising a set of computer-executable instructions implementing communication functions. The I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, server 105 or may be indirectly accessible via or attached to the user device 115.

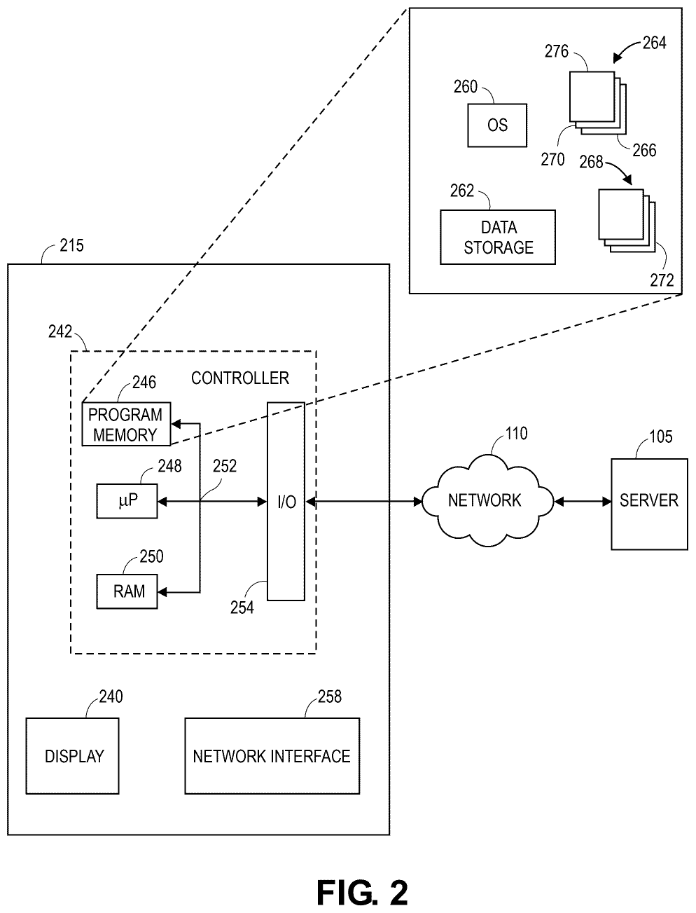

The server 105 may also be in communication with a user device 115. The user device 115 may be associated with a user receiving electronic messages generated by the server 105. The user device 115 may comprise one or more computers and/or multiple, redundant, or replicated client computers accessed by one or more users. The user device 115 may include one or more computing devices (e.g., desktop computer, laptop computer, terminal), mobile devices, wearables, smart watches, smart contact lenses, smart glasses, augmented reality glasses/headsets, virtual reality glasses/headsets, mixed or extended reality glasses/headsets, and/or other suitable electronic or electrical components. The user device 115 includes a memory and a processor for, respectively, storing and executing one or more modules, computer- executable instructions, etc. The memory may include one or more suitable storage media such as a magnetic storage device, a solid-state drive, random access memory (RAM), etc. The user device 115 may access services or other components of the computing environment 100 via the network 110. The user device 115 may be used to request or receive information/data from, and or provide information/data to, one or more applications 126 of the server 105 (e.g., the EM application 128). An example embodiment of user device 115 is shown in FIG. 2 and discussed below. While not shown in FIG. 1, the computing environment 100 may include multiple (e.g., thousands) of other user devices similar to user device 115, each communicatively coupled to server 105 via network 110 and having functionality similar to that described herein for user device 115.

In operation, the computing environment 100 generates an electronic message for an individual. In one embodiment, the EM application 128 applies the topic ML model 136 to post data, to generate topic data. While the EM application 128 is disclosed herein as performing various operations, in some embodiments such operations can instead be split among two or more applications, and/or other suitable components of the computing environment 100. The EM application 128 may obtain the post data from memory (e.g., the memory 124, the database 130), from a device (e.g., another server 105, the user device 115) via the network 110, via a post application programming interface (API), and/or in any other suitable manner. The post data may be associated with a plurality of posts, at least some of which indicate social engineering topics. For example, the topic ML model 136 identifies phishing email topics mentioned or otherwise reflected in posts. The EM application 128 may generate the electronic message feature data using the topic data.

In one embodiment, the EM application 128 generates security inference data indicating at least one security inference by applying the security inference ML model 138 to security intelligence data. The EM application 128 may obtain the security intelligence data in any suitable manner, such as that just described with respect to the EM application 128 obtaining post data. The security inferences may include social engineering trends such as, for example, whether particular types of phishing are becoming more prevalent (e.g., spear phishing, credential phishing, etc.), recent phishing message topics, emotional triggers used by recent phishing messages, and/or any other suitable security inferences. In some embodiments, the security intelligence data is specifically related to electronic messages of phishing (or other fraudulent) attacks that are known to have been successful. The EM application 128 may generate the electronic message feature data using the security inference data.

The EM application 128 may generate electronic message feature data, e.g., using the topic data and/or the security inference data, and/or otherwise obtain the electronic message feature data (e.g., retrieving the electronic message feature data from the memory 124, the database 130, etc.). The electronic message feature data may indicate features that are desired for an electronic message/message template, such as features relevant to social engineering and/or social engineering awareness training. The features may include one or more of a category of the electronic message, a subject of the electronic message, a sender of the electronic message, a level of urgency of the electronic message, a spelling error in the electronic message, a grammatical error in the electronic message, an emotional trigger classification (e.g., a classification of the emotion that language in the electronic message is intended to evoke, such as fear, sympathy, etc.), and/or any other suitable electronic message feature. The EM application 128 may store the electronic message feature data in memory, such the memory 124 and/or the database 130.

In one embodiment, the EM application 128 generates a plurality of electronic message templates by applying the generative ML model 134 to the electronic message feature data. The generated templates reflect one or more features indicated by the electronic message feature data. For example, a first electronic message template may reflect an electronic message subject, include spelling errors, and use emotional trigger language intended to evoke fear in the reader, whereas a second electronic message template may reflect a different subject, not include spelling errors, and use emotional trigger language intended to evoke sympathy in the reader, as indicated by the electronic message features of each respective template. The EM application 128 may store the electronic message templates in memory, such as the memory 124 and/or the database 130.

The EM application 128 may generate a plurality of susceptibility metrics by applying the predictive ML model 140 to one or more of (i) information regarding one or more organizational characteristics of the individual, (ii) historical electronic message data indicating historical electronic message information of the organization for the individual, or (iii) electronic message template characteristic data indicating characteristics of the plurality of electronic message templates. The EM application 128 may obtain the organizational characteristics information, historical electronic message data, and/or the electronic message template characteristic data from any suitable source(s), such as the memory 124, the database 130, and/or a device (e.g., another server similar to server 105, user device 115, etc.).

The information regarding one or more organizational characteristics of the individual may include one or more of: a job title, a job type, a pay grade, an employment division, a type of business, tenure at the organization, a telecommuter status, an employment classification (e.g., employee, contractor, etc.), a system access level (e.g., low/medium/high/critical level of access to one or more computer system), and/or any other suitable information.

The historical electronic message information may indicate one or more of: historical interactions of the individual with electronic messages of the organization (e.g., opening, forwarding, opening embedded hyperlinks, etc.), historical reports provided by the individual of historical electronic message interactions (e.g., whether the individual self-reported interacting with electronic messages, such as phishing electronic messages), historical electronic message survey information of the individual (e.g., responses of the individual to surveys), and/or any other suitable information), and/or any other suitable information.

The characteristics of the electronic message templates may include one or more of: a spam score (e.g., a score indicating the likelihood of the electronic message, based on the respective template, getting caught in a spam filter), an electronic message category, an electronic message topic, a type of sender (e.g., person, organization, etc.), a level of urgency (e.g., urgent, non-urgent), personalization (e.g., whether the electronic message is personalized), spelling errors, grammatical errors, reference to a legitimate company or other entity in the electronic message, one or more images in the electronic message, or one or more emotional trigger classifications (e.g., using language in the electronic message evoking greed, fear, sympathy, excitement, etc.), and/or any other suitable information. In at least some aspects, the electronic message template characteristic data may include at least part of the electronic message feature data, e.g., the electronic message feature data used by the generative ML model 134 to generate the plurality of electronic message templates.

Each susceptibility metric may be associated with both a particular individual and a particular electronic message template, and indicates a predicted probability of the particular individual interacting with (e.g., responding to, clicking on a link within, etc.) an electronic message generated using the particular electronic message template. The EM application 128 may select a particular electronic message template for an individual based at least upon the susceptibility metric associated with the individual for the particular electronic message template. For example, the EM application 128 may select the template having the highest susceptibility metric for that individual, i.e., the susceptibility metric that indicates the individual is most likely to interact with an electronic message generated using that template.

The EM application 128 selects the particular electronic message template for each individual using a rule-based algorithm. In some embodiments, the EM application 128 selects the template using only the susceptibility metric (e.g., selects the template associated with the highest susceptibility metric for that individual). In other embodiments, the EM application 128 selects the template using the susceptibility metric and one or more other factors. For example, the rule-based algorithm may use the susceptibility metric, the system access level of the individual, historical electronic message survey information of the individual, and/or historical electronic message campaign results of the individual to determine which electronic message template to select for the individual. As a more specific example, a first electronic message template may have a susceptibility metric predicting a 67% percent likelihood Alice will open the electronic message generated using the first electronic message template. A second electronic message template may have a susceptibility metric predicting a 25% percent likelihood Alice will open the electronic message generated using the second electronic message template. Other factors considered by the rule-based algorithm in this example when selecting the electronic message template include Alice having a high level of system access, Alice's survey answers regarding the effectiveness of past social engineering awareness training by Alice's employer, and Alice opening 1 of 5 phishing emails sent last year to Alice by her employer. The EM application 128 may select the first template based upon its associated susceptibility metric predicting a higher likelihood of Alice interacting with the electronic message generated using the first electronic message template, as compared to the second electronic message template, as well as the other factors.

The EM application 128 may generate the electronic message based upon the particular electronic message template. For example, the electronic message template may be an electronic message having various fields to be populated/filled-in, such as the recipient's name, the recipient's company, the sender's information, the date, and/or other suitable information specific to the individual and/or other circumstances. The EM application 128 may add the appropriate information to the fields to generate the electronic message. The EM application 128 may then cause the electronic message to be provided to a user device 115 associated with the individual. This may include transmitting the electronic message, flagging the electronic message for transmission to the individual, linking the electronic message to an account of the individual, or any other suitable means of causing the electronic message to be provided to the user device 115 of the individual.

In some embodiments, the server 105 and/or EM application 128 also monitors whether and/or how the individual interacts with the electronic message. Monitoring the interactions of the individual with the electronic message may include detecting an interaction by the individual with interactive content of the electronic message (e.g., clicking on a hyperlink), receiving a reply electronic message from the individual in response to the respective electronic message, receiving feedback from the individual associated with the respective electronic message (e.g., via a social engineering awareness training survey), and/or any other suitable automated and/or computer-implemented monitoring techniques. In one example, a user opening the electronic message on the user device 115 causes the user device 115 to generate and transmit a signal to the server 105 and/or EM application 128, via the network 110, indicating the electronic message was opened. In another example, when the individual selects a hyperlink embedded in the electronic message, the user device 115 generates and transmits a signal to the server 105 and/or EM application 128 indicating the individual interacted with the hyperlink.

In some embodiments, any of the various data obtained, retrieved, operated on, generated, etc., in the course of generating the electronic message templates, generating the electronic message, and/or monitoring the individual, may be stored in memory, such as the memory 124 and/or the database 130. This may include the input and/or output data of any of the ML models 132, 134, 136, 138, 140. In some embodiments, such data is used to retrain one or more of the ML models 132, 134, 136, 138, 140.

The computing environment 100 may include additional, fewer, and/or alternate components, and may be configured to perform additional, fewer, or alternate actions, including components/actions described herein. For instance, information described as being stored at database 130 may be stored at memory 124, and therefore database 130 may be omitted. Moreover, it should be appreciated that additional and/or alternative connections between components shown in FIG. 1 may be implemented. As just one example, server 105 and database 130 may be connected via a direct communication link (not shown in FIG. 1) instead of, or in addition to, via network 110.

### EXAMPLE USER DEVICE

FIG. 2 depicts an example user device 215, which may be, for example, the user device 115. The user device 215 includes a display 240, a network interface 258, a user-input device (not shown), and a controller 242. The controller 242 may include a program memory 246, a microcontroller/processor/microprocessor 248 such as the processor 120, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268.

The data storage 262 may include data such as application data for the plurality of applications 264, routine data for the plurality of routines 268, and/or other data necessary to interact with the server 105 through the network 110. In some embodiments, the controller 242 may also include, or otherwise be communicatively connected to, other data storage mechanisms (e.g., one or more hard disk drives, optical storage drives, solid state storage devices, etc.) that reside within the user device 215.

The network interface 258 may communicate with the one or more components or devices, such as server 105, via any suitable wireless communication protocol network, such as a wireless telephony network (e.g., GSM, CDMA, LTE, 5G, 6G, ultrawideband, etc.), a Wi-Fi network (e.g., having 802.11 standards), a WiMAX network, a Bluetooth network, etc. The user-input device (not shown) may include a “soft” keyboard that is displayed on the display 240 of the user device 215, an external hardware keyboard communicating via a wired and/or a wireless connection (e.g., a Bluetooth keyboard), an external mouse, a touchscreen, a stylus, and/or any other suitable user-input device.

The processor 248 may include one or more processors. The example processor 248 is adapted and/or configured to execute any one or more of the plurality of software applications 264 and/or any one or more of the plurality of software routines 268 residing in the program memory 246, in addition to other software applications.

One of the plurality of applications 264 may be a native application and/or web browser 270 that may be implemented as a series of machine-readable instructions for receiving, interpreting, and/or displaying application screens or web page information from the server 105 while also receiving inputs from the user. Another application of the plurality of applications may include an embedded web browser 276 that may be implemented as a series of machine-readable instructions for receiving, interpreting, and/or displaying web page information.

In the example embodiment of FIG. 2, one of the plurality of applications 264 is an EM client application 266 for performing or facilitating the various user/client-side tasks and/or functions discussed above in connection with FIG. 1, such as displaying the electronic messages generated by the server 105, generating/transmitting data used by server 105 to monitor user interactions with electronic messages, providing explicit electronic message feedback (e.g., electronic message survey information about the effectiveness of the electronic message), etc. Additionally, the user may also launch or instantiate any other suitable user interface application (e.g., the native application or web browser 270, and/or any other one of the software applications 264) to access the server 105 and/or the EM application 128 to realize one or more aspects of the disclosed system.

The user device 215 may include additional, fewer, and/or alternate components, and may be configured to perform additional, fewer, or alternate actions, including components/actions described herein. Although the user device 215 is shown in FIG. 2 as including one instance of various components such as the display 240, the processor 248, etc., various aspects include the user device 215 implementing any suitable number of any of the components shown in FIG. 2 and/or omitting any suitable ones of the components shown in FIG. 2. Moreover, various aspects include the user device 215 including any suitable additional component(s) not shown in FIG. 2, such as but not limited to the example components described above. Furthermore, it should be appreciated that additional and/or alternative connections between components shown in FIG. 2 may be implemented.

### ML Model Training

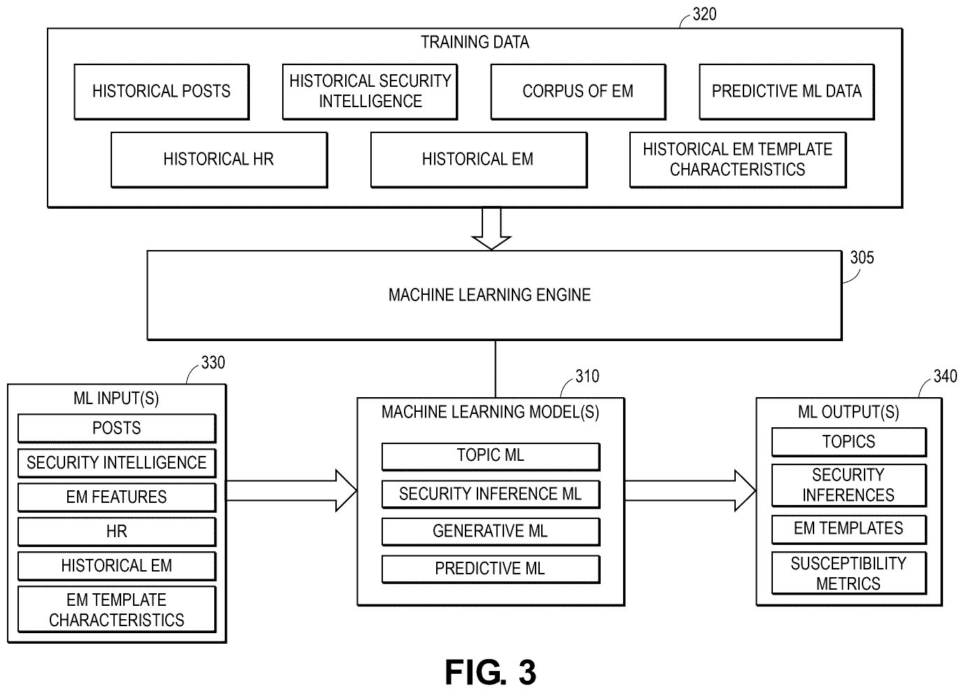

FIG. 3 illustrates an example data flow diagram for training and operation of an ML model 310, such as one or more of the ML models 132. Although FIG. 3 illustrates various ML models 310, and various types of ML training data 320, inputs 330, and outputs 340, this does not imply that the same set of training data, inputs, and outputs shown apply to all of the ML models 310, or that any specific technique discussed herein is necessarily used for all of the ML models 310, as further described below.

An ML engine 305 (e.g., the ML module 144 of the server 105) may include one or more hardware and/or software components to obtain, create, (re)train, fine-tune, and/or store one or more ML models, such as the ML model 310. To train the ML model 310, the ML engine 305 may use training data 320. A server, such as server 105, may obtain and/or have available one or more types of training data 320 (e.g., training data stored in the database 130). In one aspect, at least some of the training data 320 may be labeled to aid in (re) training and/or fine-tuning the ML model 310. During training of the ML model 310 by the ML engine 305, the ML model 310 may be configured to process the training data 320 to learn associations and relationships in the training data 320.

In some embodiments, the ML engine 305 updates the training data 320 as needed, e.g., to include new data. Such data may be stored as updated training data 320. Subsequently, the ML model 310 may be retrained based upon the updated training data 320, or the new portions thereof, which may cause the ML model 310 to improve over time.

In some embodiments, the ML engine 305 trains the ML model 310 using the training data 320 to generate the output 340 based on the input 330. Once trained, the ML model 310 may perform operations on one or more data inputs 330 to produce a desired data output 340, as discussed above with reference to ML models 134, 136, 138, and 142. In one aspect, the ML model 310 is loaded at runtime from a database (e.g., model 310 loaded by ML engine 305 from the database 130). The server and/or ML engine 305 may obtain the input data 330 (e.g., from the database 130), and the ML engine 305 may provide the input data 330 to the trained ML model 310 as an input, for the ML model 310 to generate the output 340.

In at least some aspects, the same server and/or other suitable component/device, both trains the ML model 310, and executes the trained ML model 310. In at least some aspects, a first server and/or other suitable component/device trains the ML model 310, and a second server and/or other suitable component/device executes the trained ML model 310.

### Generative ML Model

In one embodiment, the ML model 310 is the generative ML model 134, e.g., a model trained by ML engine 305 to include generative functionality for creating new content that is in some ways similar to, or otherwise inspired by, existing examples, and/or reflective of desired features/characteristics. As noted above, in some of these embodiments, the ML model is an LLM. The LLM may operate upon and generate only text or, in other embodiments, may be a multimodal LLM that operates upon and/or generate text and also other types of content (e.g., images, audio, etc.).

To use the generative ML model 134, in some of these embodiments, the server 105 (and/or a user thereof) generates a text prompt as an input to the generative ML model 134, causing the generative ML model 134 to process the text prompt and output text content responsive to the text prompt. The generative ML model 134 may include a deep neural network and may perform various natural language processing (NLP) tasks (e.g., classifying text, answering questions, summarizing text, generating text) as needed to understand a text query/prompt and generate a response to the text query/prompt. As one example, the prompt may be “Create an email message that would strongly entice a reader who does not know the sender to respond to the email message, the email message having Characteristics X and Y”, where Characteristics X and Y are characteristics described above (e.g., a topic, a security inference, etc.).

The LLM may have a transformer model architecture with an encoder and decoder, and may characteristics tokenize inputs/text. The transformer model may incorporate self-attention mechanisms to facilitate faster learning/training and/or more accurate output. In some embodiments, the LLM includes many layers of neural networks, possibly including a number of embedding layers, a number of feedforward layers, and a number of recurrent layers. In alternative embodiments, the generative ML model 134 is not an LLM. For example, the generative ML model 134 may instead include a less complex neural network.

The generative ML model 134 may have been trained by server 105 or another computing system using unsupervised or semi-supervised learning, for example, and with training data of the appropriate modality (text) or modalities (e.g., text as well as images and/or audio). The generative ML model 134 may be a general-purpose model (e.g., trained on a wide array of publicly available datasets such as web pages, documents, etc., available via the Internet) or may be a domain-specific model (e.g., trained on custom and/or proprietary datasets, such as historical phishing emails). In some embodiments, the generative ML model 134 is an LLM with parameters tuned, via the training process, specifically for high performance in the context of generating text having one or more particular qualities and/or characteristics known to be associated with phishing emails or other electronic messages.

### Topic ML Model

In one embodiment, the ML model 310 is the topic ML model 136, e.g., a model trained by ML engine 305 using training data 320 stored in a memory (e.g., database 130). In some such embodiments, the training data 320 includes historical post data comprising historical posts. The topic ML model 136 may be trained to identify social engineering topics of the posts. The training may use supervised training techniques (e.g., with manually added labels of social engineering topics for posts in a corpus of historical posts), and/or unsupervised learning techniques, depending on the type of the topic ML model 136. As an unsupervised example, the topic ML model 136 may be an LLM trained on a general corpus of electronic documents. As used herein, “training” of a model can refer to initial training, retraining, and/or tuning of a model. Once trained, the topic ML model 136 may receive as an input 330 post data comprising current/recent posts (e.g., within some predetermined past time period), and generate as an output 340 topic data indicating the social engineering topics of the input 330. For example, the server 105 may receive post data comprising actual posts obtained from Facebook, Instagram, and X (formerly Twitter) over some recent time period and via associated APIs. The server 105, via the ML engine 305, may then provide the post data as an input 330 to the topic ML model 136. The topic ML model 136 may then generate, as an output 340, the topic data indicating social engineering topics of the input posts. In some embodiments, the topic ML model 136 also includes a graph ML model. The graph ML model receives (as input 330) post data comprising current/recent posts (e.g., within some predetermined past time period), and generates (as output 340) topic data indicating the social engineering topics of the input 330 and an importance and/or popularity metric of each topic. In some embodiments, the EM application 128 uses such calculated importance and/or popularity metrics to decide which types of templates to generate.

### Security Inference ML Model

In one embodiment, the ML model 310 is the security inference ML model 138, e.g., a model trained by the ML engine 305 using training data 320 that is stored in a memory and includes historical security intelligence data. In some such embodiments, the security inference ML model is trained to identify security inferences from the historical security intelligence data. The historical security intelligence data may include, for example, the content of actual phishing emails, or the content of phishing emails known to be successful. The training may use supervised training techniques (e.g., with manually added labels of security inferences associated with a corpus of historical phishing emails), and/or unsupervised learning techniques, depending on the type of the security inference ML model 138. As an unsupervised example, the security inference ML model 138 may be an LLM trained on a general corpus of electronic documents. Once trained, the security inference ML model 138 may receive as an input 330 security intelligence data (e.g., a collection of actual phishing emails), and generate as an output 340 security inference data indicating the security inferences indicated by the input data 330. For example, the server 105 may receive security intelligence data from a security intelligence data server via a network, such as the network 110. As an example, the security intelligence data may indicate, among other social engineering information, the top five phishing trends over the last 30 days. The server, via the ML engine 305, may provide the security intelligence data as an input 330 to the security inference ML model 138. The security inference ML model 138 may generate, as an output 340, the security inference data indicating the top five phishing trends.

### Predictive ML Model

In one embodiment, the ML model 310 is the predictive ML model 140, e.g., a model trained by the ML engine 305 using training data 320 stored in a memory and including predictive ML training data. The predictive ML training data may comprise, for a plurality of individuals, historical information regarding one or more organizational characteristics of the individual, historical electronic message data, and/or historical electronic message template characteristic data. The predictive ML model 140 may be trained to generate susceptibility metrics (e.g., scores), each susceptibility metric being associated with a combination of a particular individual and a particular electronic message template. Once trained, the predictive ML model 140 may receive, as inputs 330, information regarding one or more organizational characteristics of the individual, the historical electronic message data of the individual, and/or the electronic message template characteristic data of the electronic message template, and generate as an output 340 one or more susceptibility metrics, wherein each susceptibility metric is associated with the individual and the electronic message template. For example, the server 105 may provide as an input 330 to the predictive model (i) Alice's organizational characteristics indicating her job title, a job type, a pay grade, and tenure at the organization she works for; (ii) Alice's historical electronic message data indicating how many historical phishing emails she has received from the organization, how many historical phishing emails Alice has interacted with, which historical phishing emails Alice has reported interacting with to the organization, and historical survey responses pertaining to the historical phishing emails and historical social engineering awareness training by the organization; and (iii) electronic message template characteristic data indicting, for the electronic message templates, spam scores, electronic message categories, and electronic message topics. The predictive ML model 140 may generate as an output 340, a susceptibility metric for Alice associated with each of the electronic message templates, and indicating the predicted likelihood Alice will open the associated electronic message template.

While various ML models 310 are described with respect to FIG. 3 and more generally throughout the disclosure, a single ML model may provide at least some functionality associated with one or more separately described ML models. For example, the ML model 136 may be trained to provide the functionality of both the topic ML model 136 and the security inference ML model 138. Conversely, the functionality described with respect to a single ML model may be implemented by one or more separate ML models. Moreover, one or more ML models may be trained to have additional functionality that may not be expressly described. Furthermore, although each of the ML models is described as generating specific output(s) based upon specific input(s), the ML models may receive other input(s) and/or produce other output(s) not expressly described.

### EXAMPLE ELECTRONIC MESSAGING PLATFORM

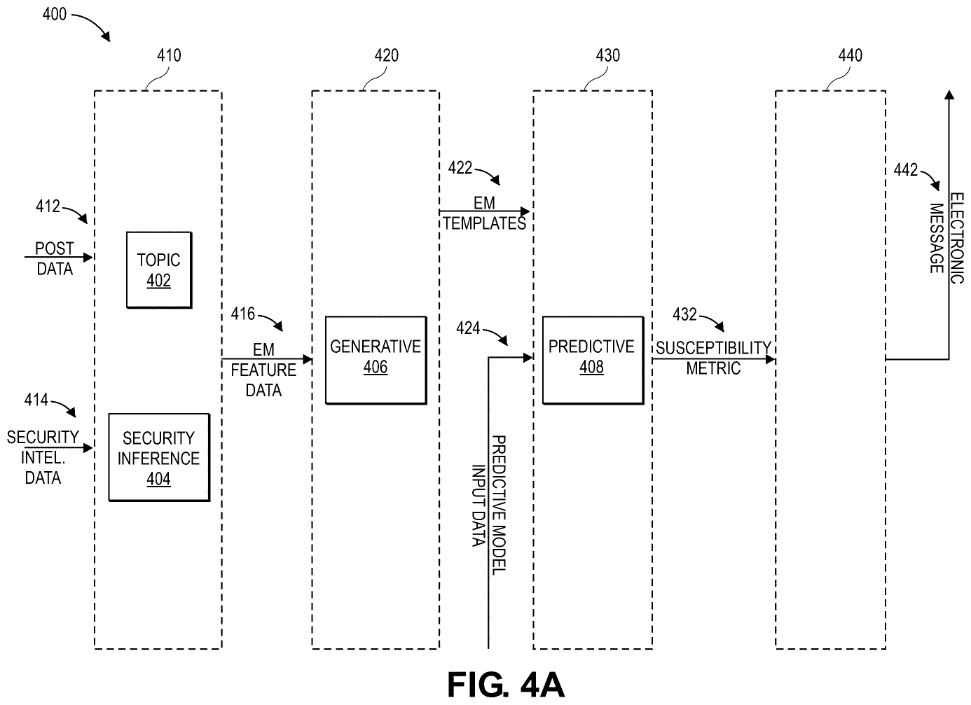

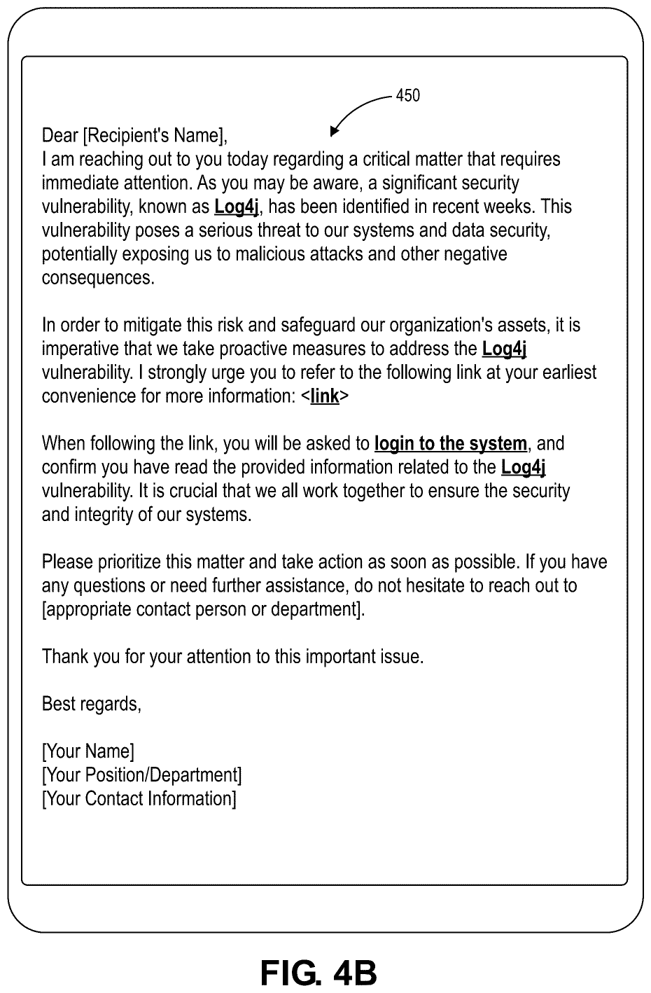

FIG. 4A is an example workflow block diagram 400 of an example electronic message platform for template generation and risk-based matching for electronic messages, in accordance with embodiments described herein. The workflow 400 may be performed by the EM application 128. The example workflow block diagram 400 generally illustrates the electronic message platform, executable as a set of computer-executable instructions stored on the one or more memories and executed by one or more processors (e.g., the EM application 128 stored on the memory 124 and executed by the processor 120) to receive one or more inputs and generate one or more outputs. The electronic message platform may include, and/or operate in conjunction with, one more components, such as a topic model 402 (e.g., the topic ML model 136), a security inference model 404 (e.g., the security inference ML model 138), a generative model 406 (e.g., the generative ML model 134), and a predictive model 408 (e.g., the predictive ML model 140) as illustrated in FIG. 4, although any other suitable device(s) or component(s) may be used.

At a first time frame 410, the inputs for the electronic message platform may include post data 412 and security intelligence data 414, and the output may include electronic message feature data 416. The first time frame 410 may represent the electronic message platform obtaining the inputs 412, 414, e.g., from one or more memories, components and/or devices communicatively connected to the electronic message platform, such as the memory 124, the database 130, one or more other servers similar to server 105, one or more user devices (e.g., including user device 115), and/or any other suitable entities or components. During the first time frame 410, the electronic message platform (i) provides the post data 412 as an input to the topic model 402 to generate topic data; (ii) provides the security intelligence data 414 as an input to the security inference model 404 to generate security inference data; and (iii) generates the electronic message feature data 416 as an output using the security inference data and topic data. In at least some aspects, the electronic message platform stores the topic data and/or security inference data in a memory communicatively coupled to the electronic message platform (e.g., for additional use as training data for retraining the topic model 402 and/or security inference model 404).

Although the electronic message feature data 416 can indicate one or more social engineering topics and/or security inferences, the electronic message feature data 416 may also and/or instead indicate other electronic message features not generated by the topic model 402 and/or the security inference model 404. In some embodiments, the electronic message feature data indicates other electronic message features such as a category, a subject, a sender, a level of urgency, a spelling error, a grammatical error, and/or an emotional trigger classification, as previously described. In some such embodiments, the electronic message feature data 416 indicating the other electronic message features is stored in one or more memories communicatively coupled to the electronic message platform, is generated by the electronic message platform, and/or is provided by one or more components/devices communicatively coupled to the electronic message platform. In one example, the organization associated with generating electronic messages 442 generates the electronic message feature data 416 unrelated to social engineering inferences/trends and topics, stores the electronic message feature data in a database of the electronic message platform, and supplements the electronic message feature data 416 with the electronic message features generated from the topic model 402 and/or security inference model 404.

At a second time frame 420, the input for the electronic message platform includes the electronic message feature data 416, and the output includes a plurality of electronic message templates 422. During the first time frame 410 or the second time frame 420, the electronic message platform stores the electronic message feature data 416 in a memory, such as the memory 124, the database 130 (e.g., as model training data), and/or any other suitable memory. During the second time frame 420, the electronic message platform provides the electronic message feature data 416 as an input to the generative model 406, which generates as an output the plurality of electronic message templates 422.

At a third time frame 430, the inputs for the electronic message platform include the electronic message templates 422 and predictive model input data 424, and the output includes a plurality of susceptibility metrics 432. During the second time frame 420 or the third time frame 430, the electronic message platform stores the plurality of electronic message templates 422 in a memory, such as the memory 124, the database 130 (e.g., as model training data), and/or any other suitable memory. During the third time frame 430, the electronic message platform obtains the predictive model input data 424, which comprises information regarding one or more organizational characteristics of the individual, historical electronic message data of the organization for the individual, and/or electronic message template characteristic data of the electronic message templates 422. The electronic message platform may obtain the predictive model input data 424 from one or more memories, components and/or devices communicatively connected to the electronic message platform, such as the memory 124, the database 130, one or more servers 105, one or more user devices 115, and/or any other suitable memories, devices and/or components. The third time frame 430 may represent the electronic message platform providing the predictive model input data 424 as an input to the predictive model 408, which generates as an output a plurality of susceptibility metrics 432. In some embodiments, each susceptibility metric of the plurality of susceptibility metrics 432 is associated with both an individual and a respective electronic message template of the plurality of electronic message templates 422.

At a fourth time frame 440, the input for the electronic message platform includes the susceptibility metrics 432, and the output includes the electronic message 442. During the third time frame 430 or the fourth time frame 440, the electronic message platform stores the plurality of susceptibility metrics 432 in a memory, such as the memory 124, the database 130 (e.g., as model training data), and/or any other suitable memory. During the fourth time frame 440, the electronic message platform (i) selects a particular electronic message template of the plurality of electronic message templates 422, based at least upon the susceptibility metric associated with the individual and the particular electronic message template; (ii) generates the electronic message 442 for the individual based upon the particular electronic message template; and (iii) causes the electronic message 442 to be provided to a user device associated with the individual. Also during the fourth time frame 440, the electronic message platform may store the electronic message 442 in memory.

Of course, it should be understood that the inputs and/or outputs depicted in FIG. 4A are for ease of illustration only, and may not represent and/or include every input/output.

In one example to illustrate the workflow block diagram 400, the electronic message platform is associated with a business using the electronic message platform to provide social engineering awareness training to its employees. The electronic message platform obtains the post data 412 using APIs configured to retrieve posts from a plurality of social media servers (e.g., Facebook, X, Reddit, Instagram, etc.) via a network, such as the network 110. The electronic message platform stores the post data 412 in a database, such as the database 130. The electronic message platform provides the post data 412 to the topic model 402. The topic model 402 extracts social engineering topics mentioned in the posts of the post data 412, to generate the topic data. In at least some aspects, each social engineering topic is associated with a ranking (e.g. centrality score, topic frequency, etc.) or other metric which indicates the overall impact of the ranking or other metric in terms of importance and/or popularity. In the present example, the topic data generated by the topic model 402 indicates “log4j” as a social engineering topic.

The electronic message platform obtains the security intelligence data 414 from a server communicatively coupled to the electronic message platform via the network, the server being associated with a cyber intelligence organization which provides cyber security data, including security inferences. The electronic message platform stores the security intelligence data 414 in the database. The electronic message platform provides the security intelligence data 414 to the security inference model 404. The security inference model 404 extracts security inferences indicated in the security intelligence data 414, to generate the security inference data. In the present example, the security inference data generated by the security inference model 404 indicates credential phishing as a security inference.

The electronic message platform provides the electronic message feature data 416 to the generative model 406. The generative model 406 generates several electronic message templates 422 for the business to use for its social engineering awareness training, each of which includes at least some of the electronic message features of the electronic message feature data 416. The electronic message platform stores the electronic message templates 422 in an electronic message template database.

FIG. 4B illustrates an example log4j electronic message template 450 generated using the workflow 400. The log4j electronic message template 450 includes text associated with a log4j vulnerability according to the post topic generated by the topic model 422, as well as text and an associated link associated with credential stealing. This text is indicated in FIG. 4B as bold and underlined text.

The electronic message platform can be communicatively coupled to multiple databases associated with the business which collectively store the predictive model input data 424, including an organizational database storing organizational characteristics of the business' employees, an electronic message database storing historical electronic message information of the business' employees, and the previously-referenced electronic message template database storing electronic message template characteristic data of the electronic message templates 422 of the business. To generate an electronic message 442 for an employee Brian, the electronic message platform retrieves the predictive model input data 424 associated with Brian. This includes retrieving (i) the organizational characteristics information indicating Brian's organizational characteristics, from the organizational database; (ii) the historical electronic message data indicating Brian's historical electronic message information, from the electronic message database; and (iii) the electronic message template characteristic data indicating electronic message template characteristics of the businesses' electronic message templates 422, from the electronic message template database. The electronic message platform provides the predictive model input data 424 associated with Brian to the predictive model 408, which generates as an output a plurality of susceptibility metrics 432, each susceptibility metric being associated with Brian and a particular electronic message template of the business, and indicating a predicted probability of Brian interacting with an electronic message generated using each of the respective electronic message templates. The electronic message platform may generate susceptibility metrics for any of the business' employees as just described with respect to Brian, using the respective employee's organizational characteristic information and historical electronic message data.

The electronic message platform selects a particular electronic message template of the plurality of electronic message templates 422, based upon the susceptibility metric associated with Brian and the particular electronic message template. In this example, the electronic message template selected is one having the highest susceptibility metric, indicating the highest likelihood that Brian will open the electronic message 442 generated using the electronic message template, although the selection may be based upon any other criteria associated with the susceptibility metric. In this example, the electronic message platform automatically selects the template having the highest susceptibility metric. The electronic message platform may select electronic message templates for any of the business' employees as just described with respect to Brian.

The electronic message platform generates the electronic message 442 for Brian based upon the particular electronic message template. This may include filling in one or more fields of the electronic message template with information associated with Brian, which may include Brian's information (e.g., name), information associated with the business Brian works for (e.g., sender's name, position, contact information), etc. The electronic message platform sends Brian's electronic message 442 to an email (or other electronic messaging) address associated with Brian. The electronic message 442 is received by an electronic message application (e.g., the electronic message client application 266) executing on Brian's desktop computer. The electronic message platform may generate electronic messages 442 for any of the business' employees in a similar manner.

The electronic message platform is configured to monitor whether Brian interacts with his electronic message 442. In one example, when Brian opens the electronic message 442, the electronic message application on his desktop computer generates and transmits a signal to the electronic message platform, indicating the electronic message 442 was opened. In one example, when Brian follows the hyperlink (which the electronic message platform may generate) in the electronic message 442, the electronic message platform receives a signal indicating the hyperlink was followed (e.g., a hyperlink directing the user to a webpage hosted by the electronic message platform). In one example, Brian replies to the electronic message 442, and the reply electronic message received by the electronic message platform indicates his interaction with the electronic message 442. In one example, the electronic message platform (or other suitable device/component) may solicit feedback from Brian regarding the electronic message 442 and/or the social engineering awareness training, e.g., via an electronic survey which provides Brian's survey responses to the electronic message platform.

### EXAMPLE METHOD FOR TEMPLATE GENERATION AND RISK-BASED MATCHING FOR ELECTRONIC MESSAGES

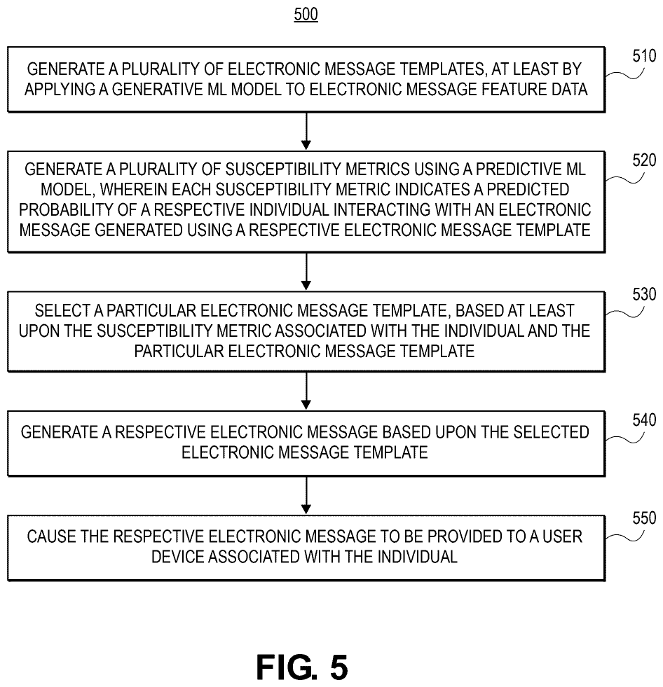

FIG. 5 depicts a flow diagram of an example computer-implemented method 500 for template generation and risk-based matching for electronic messages. One or more blocks of the method 500 may be implemented as a set of instructions stored on a computer-readable memory and executable on one or more processors. The method 500 of FIG. 5 may be implemented via one or more local or remote processors such as the processor 120, servers such as the server 105, systems such as the computing environment 100 and the electronic message platform, and/or other electronic or electrical components, which may be communicatively coupled with one another.

In an embodiment, the computer-implemented method 500 includes generating, by one or more processors, a plurality of electronic message templates, at least by applying a generative ML model, trained on a corpus of electronic messages, to electronic message feature data indicating electronic message features (block 510). The electronic message features may include one or more of a category, a subject, a sender, a level of urgency, a spelling error, a grammatical error, or an emotional trigger classification, for example.

In an embodiment, generating the plurality of electronic message templates includes generating topic data indicating at least one topic, at least by applying a topic ML model, trained on historical post data, to post data associated with a plurality of posts, and generating the electronic message feature data using the topic data. The topic ML model may include and/or operate in conjunction with a graph ML model to indicate the impact of each topic by using centrality measurement such as a page rank algorithm. Using graph ML, as an example, the vertex is defined as each topic and the edge/connection is defined as whether two topics share one or more similar characteristics, such as being mentioned within a same region or within a similar time window, or being discussed by a same person/organization, etc.

In an embodiment, generating the plurality of electronic message templates includes generating security inference data indicating at least one security inference, at least by applying a security inference ML model, trained on historical security intelligence data, to security intelligence data, and generating the electronic message feature data using the security inference data.

In an embodiment, the computer-implemented method 500 includes generating, by the one or more processors, a plurality of susceptibility metrics using a predictive ML model (block 520). Each susceptibility metric of the plurality of susceptibility metrics indicates a predicted probability of a respective individual, of a plurality of individuals, interacting with an electronic message generated using a respective electronic message template of the plurality of electronic message templates. The predictive ML model may include an XGBoost model, for example.

In some embodiments of the computer-implemented method 500, generating each susceptibility metric of the plurality of susceptibility metrics (block 520) includes applying the predictive ML model, trained on predictive ML training data, to one or more of (1) information regarding one or more organizational characteristics of the individual, (2) historical electronic message data indicating historical electronic message information of the organization for the individual, or (3) electronic message template characteristic data indicating characteristics of the plurality of electronic message templates.

In some such embodiments of the computer-implemented method 500, generating each susceptibility metric of the plurality of susceptibility metrics (block 520) includes applying the predictive ML model to the organizational characteristics information of the individual, wherein the organizational characteristics information includes one or more of: a job title, a job type, a pay grade, an employment division, a type of business, tenure at the organization, a telecommuter status, an employment classification, or a system access level.

In some such embodiments of the computer-implemented method 500, generating each susceptibility metric of the plurality of susceptibility metrics (block 520) includes applying the predictive ML model to the historical electronic message data, and wherein the historical electronic message information of the organization for the individual indicates one or more of: historical interactions of the individual with electronic messages of the organization, historical reports provided by the individual of historical electronic message interactions, or historical electronic message survey information of the individual.

In some such embodiments of the computer-implemented method 500, generating each susceptibility metric of the plurality of susceptibility metrics (block 520) includes applying the predictive ML model to the electronic message template characteristic data, and wherein the characteristics of the plurality of electronic message templates include one or more of: a spam score, a topic centrality score, an electronic message category, an electronic message topic, a sender type, an urgency, personalization, a spelling error, a grammatical error, a legitimate company reference, an image, or an emotional trigger classification.

In an embodiment, the computer-implemented method 500 includes, for each individual of the plurality of individuals, (i) selecting, by the one or more processors, a particular electronic message template of the plurality of electronic message templates, based at least upon the susceptibility metric associated with the individual and the particular electronic message template, (block 530). Selecting the particular electronic message template for each individual (block 530) may include using a rule-based algorithm, based upon one or more of a system access level of the individual, historical electronic message survey information of the individual, or historical electronic message campaign results of the individual; (ii) generating, by the one or more processors, a respective electronic message based upon the particular electronic message template (block 540); and (iii) causing, by the one or more processors, the respective electronic message to be provided to a user device associated with the individual (block 550). Causing the electronic message to be provided to the user device may include, for example, directly sending the electronic message to the user device, or instructing or requesting another system to send the electronic message to the user device. As another example, causing the electronic message to be provided to the user device may include displaying an indication of the recipient in connection with the electronic message, to trigger manual sending of the electronic message to the user device.

In an embodiment, the computer-implemented method 500 includes monitoring, by the one or more processors, how the individual interacts with the respective electronic message. Monitoring how each individual of the plurality of individuals interacts with the respective electronic message may include one or more of: (i) detecting an interaction, by the individual via the user device, with interactive content of the respective electronic message; (ii) receiving a reply electronic message, from the individual via the user device, in response to the respective electronic message; and/or (iii) receiving feedback, from the individual via the user device, associated with the respective electronic message

In an embodiment, the computer-implemented method 500 includes training one or more of the ML models (e.g., the topic ML model, the security inference ML model, the generative ML model, and/or the predictive ML model). In some embodiments, the training is performed by the one or more processors. In at least one aspect, the one or more processors are included in a first computing entity, and the training is performed by one or more processors included in a second computing entity.

It should be understood that not all blocks of the example flow diagram are required to be performed.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor- implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘____’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### EXAMPLES

The following list of examples reflects a variety of the embodiments explicitly contemplated by the present disclosure. Those of ordinary skill in the art will readily appreciate that the examples below are neither limiting of the embodiments disclosed herein, nor exhaustive of all of the embodiments conceivable from the disclosure above, but are instead meant to be exemplary in nature.

Example 1. A computer-implemented method comprising: (i) generating, by one or more processors, a plurality of electronic message templates, at least by applying a generative machine learning (ML) model, trained on a corpus of electronic messages, to electronic message feature data indicating electronic message features; (ii) generating, by the one or more processors, a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and (iii) for each individual of the plurality of individuals, (a) selecting, by the one or more processors, a particular electronic message template of the plurality of electronic message templates, based at least upon the susceptibility metric associated with the individual and the particular electronic message template, (b) generating, by the one or more processors, a respective electronic message based upon the particular electronic message template, and (c) causing, by the one or more processors, the respective electronic message to be provided to a user device associated with the individual.

Example 2. The computer-implemented method of example 1, wherein generating the plurality of electronic message templates comprises: generating topic data indicating at least one topic, at least by applying a topic ML model, trained on historical post data, to post data associated with a plurality of posts, and generating the electronic message feature data using the topic data.

Example 3. The computer-implemented method of example 2, wherein the topic ML model includes a graph ML model.

Example 4 The computer-implemented method of any one of examples 1 to 3, wherein generating the plurality of electronic message templates comprises: generating security inference data indicating at least one security inference, at least by applying a security inference ML model, trained on historical security intelligence data, to security intelligence data, and generating the electronic message feature data using the security inference data.

Example 5. The computer-implemented method of any one of examples 1 to 4, wherein the electronic message features include one or more of a category, a subject, a sender, a level of urgency, a spelling error, a grammatical error, or an emotional trigger classification.

Example 6. The computer-implemented method of any one of examples 1 to 5, wherein generating each susceptibility metric of the plurality of susceptibility metrics includes applying the predictive ML model, trained on predictive ML training data, to one or more of (1) personnel data indicating personnel information maintained by an organization for the individual, (2) historical electronic message data indicating historical electronic message information of the organization for the individual, or (3) electronic message template characteristic data indicating characteristics of the plurality of electronic message templates.

Example 7. The computer-implemented method of example 6, wherein generating each susceptibility metric of the plurality of susceptibility metrics includes applying the predictive ML model to the personnel data, and wherein the personnel information includes one or more of: a job title, a job type, a pay grade, an employment division, a type of business, tenure at the organization, a telecommuter status, an employment classification, or a system access level.

Example 8. The computer-implemented method of example 6, wherein generating each susceptibility metric of the plurality of susceptibility metrics includes applying the predictive ML model to the historical electronic message data, and wherein the historical electronic message information of the organization for the individual indicates one or more of: historical interactions of the individual with electronic messages of the organization, historical reports provided by the individual of historical electronic message interactions, or historical electronic message survey information of the individual.

Example 9. The computer-implemented method of example 6, wherein generating each susceptibility metric of the plurality of susceptibility metrics includes applying the predictive ML model to the electronic message template characteristic data, and wherein the characteristics of the plurality of electronic message templates include one or more of: a spam score, an electronic message category, an electronic message topic, a sender type, an urgency, personalization, a spelling error, a grammatical error, a legitimate company reference, an image, or an emotional trigger classification.

Example 10. The computer-implemented method of any one of examples 1 to 9, wherein the predictive ML model includes an XGBoost model.

Example 11. The computer-implemented method of any one of examples 1 to 10, wherein selecting the particular electronic message template for each individual includes using a rule-based algorithm, based upon one or more of a system access level of the individual, historical electronic message survey information of the individual, or historical electronic message campaign results of the individual.

Example 12. The computer-implemented method of any one of examples 1 to 11, further comprising monitoring, by the one or more processors, how each individual of the plurality of individuals interacts with the respective electronic message.

Example 13. The computer-implemented method of example 12, wherein monitoring how each individual of the plurality of individuals interacts with the respective electronic message includes one or more of: (i) detecting an interaction, by the individual via the user device, with interactive content of the respective electronic message; (ii) receiving a reply electronic message, from the individual via the user device, in response to the respective electronic message; or (iii) receiving feedback, from the individual via the user device, associated with the respective electronic message.

Example 14. The computer-implemented method of any one of examples 1 to 14, further comprising training the generative ML model using the corpus of electronic messages.

Example 15. The computer-implemented method of example 14, wherein training the generative ML model is performed by the one or more processors.

Example 16. The computer-implemented method of example 14, wherein the one or more processors are included in a first computing entity, and the training is performed by one or more processors included in a second computing entity.

Example 17. The computer-implemented method of any one of examples 1 to 16, further comprising training the predictive ML model using the predictive ML training data, wherein the predictive ML training data includes, (i) historical personnel data indicating personnel information maintained by the organization for a plurality of individuals, (ii) historical electronic message data indicating historical electronic message information of the organization for the plurality of individuals, and (iii) historical electronic message template characteristic data indicating characteristics of the plurality of historical electronic message templates.

Example 18. The computer-implemented method of example 17, wherein training the predictive ML model is performed by the one or more processors.

Example 19. The computer-implemented method of example 17, wherein the one or more processors are included in a first computing entity, and the training is performed by one or more processors included in a second computing entity.

Example 20. The computer-implemented method of example 2, further comprising training the topic ML model using the historical post data associated with a plurality of historical posts.

Example 21. The computer-implemented method of example 20, wherein training the topic ML model is performed by the one or more processors.

Example 22. The computer-implemented method of example 20, wherein the one or more processors are included in a first computing entity, and the training is performed by one or more processors included in a second computing entity.

Example 23. The computer-implemented method of example 4, further comprising training the topic ML model using the historical security intelligence data.

Example 24. The computer-implemented method of example 23, wherein training the security inference ML model is performed by the one or more processors.

Example 25. The computer-implemented method of example 23, wherein the one or more processors are included in a first computing entity, and the training is performed by one or more processors included in a second computing entity.

Example 26. A system comprising memory and one or more processors communicatively coupled to the memory, the one or more processors configured to (i) generate a plurality of electronic message templates, at least by applying a generative machine learning (ML) model, trained on a corpus of electronic messages, to electronic message feature data indicating electronic message features; (ii) generate a plurality of susceptibility metrics using a predictive ML model, wherein each susceptibility metric of the plurality of susceptibility indicates a predicted probability of a respective individual, of a plurality of individuals, interacting with an electronic message generated using a respective electronic message template of the plurality of electronic message templates; and (iii) for each individual of the plurality of individuals, (a) select a particular electronic message template of the plurality of electronic message templates, based at least upon the susceptibility metric associated with the individual and the particular electronic message template, (b) generate a respective electronic message based upon the particular electronic message template, and (c) cause the respective electronic message to be provided to a user device associated with the individual.

Example 27. The system of example 26, wherein to generate the plurality of electronic message templates, the one or more processors are further configured to: generate topic data indicating at least one topic, at least by applying a topic ML model, trained on historical post data, to post data associated with a plurality of posts; and generate the electronic message feature data using the topic data.

Example 28. The system of example 27, wherein the topic ML model includes a graph ML model.

Example 29. The system of any one of examples 26 to 28, wherein to generate the plurality of electronic message templates, the one or more processors are further configured to generate security inference data indicating at least one security inference, at least by applying a security inference ML model, trained on historical security intelligence data, to security intelligence data; and generate the electronic message feature data using the security inference data.

Example 30. The system of any one of examples 26 to 29, wherein the electronic message features include one or more of a category, a subject, a sender, a level of urgency, a spelling error, a grammatical error, or an emotional trigger classification.

Example 31. The system of any one of examples 26 to 30, wherein to generate each susceptibility metric of the plurality of susceptibility metrics, the one or more processors are further configured to: apply the predictive ML model, trained on predictive ML training data, to one or more of (1) personnel data indicating personnel information maintained by an organization for the individual, (2) historical electronic message data indicating historical electronic message information of the organization for the individual, or (3) electronic message template characteristic data indicating characteristics of the plurality of electronic message templates.

Example 32. The system of example 31, wherein to generate each susceptibility metric of the plurality of susceptibility metrics, the one or more processors are further configured to: apply the predictive ML model to the personnel data, and wherein the personnel information includes one or more of: a job title, a job type, a pay grade, an employment division, a type of business, tenure at the organization, a telecommuter status, an employment classification, or a system access level.

Example 33. The system of example 31, wherein to generate each susceptibility metric of the plurality of susceptibility metrics, the one or more processors are further configured to: apply the predictive ML model to the historical electronic message data, and wherein the historical electronic message information of the organization for the individual indicates one or more of: historical interactions of the individual with electronic messages of the organization, historical reports provided by the individual of historical electronic message interactions, or historical electronic message survey information of the individual.

Example 34. The system of example 31, wherein to generate each susceptibility metric of the plurality of susceptibility metrics, the one or more processors are further configured to: apply the predictive ML model to the electronic message template characteristic data, and wherein the characteristics of the plurality of electronic message templates include one or more of: a spam score, an electronic message category, an electronic message topic, a sender type, an urgency, personalization, a spelling error, a grammatical error, a legitimate company reference, an image, or an emotional trigger classification.

Example 35. The system of any one of examples 26 to 34, wherein the predictive ML model includes an XGBoost model.

Example 36. The system of any one of examples 26 to 35, wherein to select the particular electronic message template for each individual, the one or more processors are further configured to: use a rule-based algorithm based upon one or more of a system access level of the individual, historical electronic message survey information of the individual, or historical electronic message campaign results of the individual.

Example 37. The system of any one of examples 26 to 36, wherein the one or more processors are further configured to monitor how the individual interacts with the respective electronic message.

Example 38. The system of example 37, wherein to monitor how each individual of the plurality of individuals interacts with the respective electronic message, the one or more processors are further configured to one or more of: (i) detect an interaction, by the individual via the user device, with interactive content of the respective electronic message; (ii) receive a reply electronic message, from the individual via the user device, in response to the respective electronic message; or (iii) receive feedback, from the individual via the user device, associated with the respective electronic message.

Example 39. The system of any one of examples 26 to 38, further comprising training the generative ML model using the corpus of electronic messages.

Example 40. The system of example 39, wherein training the generative ML model is performed by the one or more processors.

Example 41. The system of example 39, wherein the one or more processors are included in a first computing entity, and the training is performed by one or more processors included in a second computing entity.

Example 42. The system of any one of examples 26 to 41, further comprising training the predictive ML model using the predictive ML training data, wherein the predictive ML training data includes, (i) historical personnel data indicating personnel information maintained by the organization for a plurality of individuals, (ii) historical electronic message data indicating historical electronic message information of the organization for the plurality of individuals, and (iii) historical electronic message template characteristic data indicating characteristics of the plurality of historical electronic message templates.

Example 43. The system of example 42, wherein training the predictive ML model is performed by the one or more processors.

Example 44. The system of example 42, wherein the one or more processors are included in a first computing entity, and the training is performed by one or more processors included in a second computing entity.

Example 45. The system of example 27, further comprising training the topic ML model using the historical post data associated with a plurality of historical posts.

Example 46. The system of example 45, wherein training the topic ML model is performed by the one or more processors.

Example 47. The system of example 45, wherein the one or more processors are included in a first computing entity, and the training is performed by one or more processors included in a second computing entity.

Example 48. The system of example 29, further comprising training the security inference ML model using the historical security intelligence data.

Example 49. The system of example 48, wherein training the security inference ML model is performed by the one or more processors.

Example 50. The system of example 48, wherein the one or more processors are included in a first computing entity, and the training is performed by one or more processors included in a second computing entity.

Example 51. One or more non-transitory computer-readable storage media including instructions that, when executed by one or more processors, cause the one or more processors to: (i) generate a plurality of electronic message templates, at least by applying a generative machine learning (ML) model, trained on a corpus of electronic messages, to electronic message feature data indicating electronic message features; (ii) generate a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and (iii) for each individual of the plurality of individuals, (a) select a particular electronic message template of the plurality of electronic message templates, based at least upon the susceptibility metric associated with the individual and the particular electronic message template, (b) generate a respective electronic message based upon the particular electronic message template, and (c) cause the respective electronic message to be provided to a user device associated with the individual.

Example 52. The one or more non-transitory computer-readable storage media of example 51, wherein to generate the plurality of electronic message templates, the instructions further cause the one or more processors to: generate topic data indicating at least one topic, at least by applying a topic ML model, trained on historical post data, to post data associated with a plurality of posts; and generate the electronic message feature data using the topic data.

Example 53. The one or more non-transitory computer-readable storage media of example 52, wherein the topic ML model includes a graph ML model.

Example 54. The one or more non-transitory computer-readable storage media of any one of examples 51 to 53, wherein to generate the plurality of electronic message templates, the instructions further cause the one or more processors to: generate security inference data indicating at least one security inference, at least by applying a security inference ML model, trained on historical security intelligence data, to security intelligence data; and generate the electronic message feature data using the security inference data.

Example 55. The one or more non-transitory computer-readable storage media of one of examples 51 to 54, wherein the electronic message features include one or more of a category, a subject, a sender, a level of urgency, a spelling error, a grammatical error, or an emotional trigger classification.

Example 56. The one or more non-transitory computer-readable storage media of one of examples 51 to 55, wherein to generate each susceptibility metric of the plurality of susceptibility metrics, the instructions further cause the one or more processors to: apply the predictive ML model, trained on predictive ML training data, to one or more of (1) personnel data indicating personnel information maintained by an organization for the individual, (2) historical electronic message data indicating historical electronic message information of the organization for the individual, or (3) electronic message template characteristic data indicating characteristics of the plurality of electronic message templates.

Example 57. The one or more non-transitory computer-readable storage media of example 56, wherein to generate each susceptibility metric of the plurality of susceptibility metrics, the instructions further cause the one or more processors to: apply the predictive ML model to the personnel data, and wherein the personnel information includes one or more of: a job title, a job type, a pay grade, an employment division, a type of business, tenure at the organization, a telecommuter status, an employment classification, or a system access level.

Example 58. The one or more non-transitory computer-readable storage media of example 56, wherein to generate each susceptibility metric of the plurality of susceptibility metrics, the instructions further cause the one or more processors to: apply the predictive ML model to the historical electronic message data, and wherein the historical electronic message information of the organization for the individual indicates one or more of: historical interactions of the individual with electronic messages of the organization, historical reports provided by the individual of historical electronic message interactions, or historical electronic message survey information of the individual.

Example 59. The one or more non-transitory computer-readable storage media of example 56, wherein to generate each susceptibility metric of the plurality of susceptibility metrics, the instructions further cause the one or more processors to: apply the predictive ML model to the electronic message template characteristic data, and wherein the characteristics of the plurality of electronic message templates include one or more of: a spam score, an electronic message category, an electronic message topic, a sender type, an urgency, personalization, a spelling error, a grammatical error, a legitimate company reference, an image, or an emotional trigger classification.

Example 60. The one or more non-transitory computer-readable storage media of any one of examples 51 to 59, wherein the predictive ML model includes an XGBoost model.

Example 61. The one or more non-transitory computer-readable storage media of any one of examples 51 to 60, wherein to select the particular electronic message template for each individual, the instructions further cause the one or more processors to: use a rule-based algorithm based upon one or more of a system access level of the individual, historical electronic message survey information of the individual, or historical electronic message campaign results of the individual.

Example 62. The one or more non-transitory computer-readable storage media of any one of examples 51 to 61, wherein the instructions further cause the one or more processors to monitor how the individual interacts with the respective electronic message.

Example 63. The one or more non-transitory computer-readable storage media of any one of example 62, wherein to monitor how each individual of the plurality of individuals interacts with the respective electronic message, the instructions further cause the one or more processors to one or more of: (i) detect an interaction, by the individual via the user device, with interactive content of the respective electronic message; (ii) receive a reply electronic message, from the individual via the user device, in response to the respective electronic message; or (iii) receive feedback, from the individual via the user device, associated with the respective electronic message.

Example 64. The one or more non-transitory computer-readable storage media of any one of examples 51 to 63, further comprising training the generative ML model using the corpus of electronic messages.

Example 65. The one or more non-transitory computer-readable storage media of example 64, wherein training the generative ML model is performed by the one or more processors.

Example 66. The one or more non-transitory computer-readable storage media of example 64, wherein the one or more processors are included in a first computing entity, and the training is performed by one or more processors included in a second computing entity.

Example 67. The one or more non-transitory computer-readable storage media of any one of examples 51 to 66, further comprising training the predictive ML model using the predictive ML training data, wherein the predictive ML training data includes, (i) historical personnel data indicating personnel information maintained by the organization for a plurality of individuals, (ii) historical electronic message data indicating historical electronic message information of the organization for the plurality of individuals, and (iii) historical electronic message template characteristic data indicating characteristics of the plurality of historical electronic message templates.

Example 68. The one or more non-transitory computer-readable storage media of example 67, wherein training the predictive ML model is performed by the one or more processors.

Example 69. The one or more non-transitory computer-readable storage media of example 67, wherein the one or more processors are included in a first computing entity, and the training is performed by one or more processors included in a second computing entity.

Example 70. The one or more non-transitory computer-readable storage media of example 52, further comprising training the topic ML model using the historical post data associated with a plurality of historical posts.

Example 71. The one or more non-transitory computer-readable storage media of example 70, wherein training the topic ML model is performed by the one or more processors.

Example 72. The one or more non-transitory computer-readable storage media of example 70, wherein the one or more processors are included in a first computing entity, and the training is performed by one or more processors included in a second computing entity.

Example 73. The one or more non-transitory computer-readable storage media of example 54, further comprising training the topic ML model using the historical security intelligence data.

Example 74. The one or more non-transitory computer-readable storage media of example 73, wherein training the security inference ML model is performed by the one or more processors.

Example 75. The one or more non-transitory computer-readable storage media of example 73, wherein the one or more processors are included in a first computing entity, and the training is performed by one or more processors included in a second computing entity.

Example 76. The computer-implemented method of any one of examples 1 to 25, wherein generating each susceptibility metric of the plurality of susceptibility metrics includes applying the predictive ML model, trained on predictive ML training data, to one or more of (1) historical electronic message data indicating historical electronic message information for the individual, or (2) electronic message template characteristic data indicating characteristics of the plurality of electronic message templates.

Example 77. The computer-implemented method of any one of examples 1 to 25, or example 76, wherein generating each susceptibility metric of the plurality of susceptibility metrics includes applying.

Example 78. The system of any one of examples 26 to 50, wherein to generate each susceptibility metric of the plurality of susceptibility metrics, the one or more processors are further configured to: apply the predictive ML model, trained on predictive ML training data, to one or more of (1) historical electronic message data indicating historical electronic message information of the organization for the individual, or (2) electronic message template characteristic data indicating characteristics of the plurality of electronic message templates.

Example 79. The system of any one of examples 26 to 50, or example 78, wherein to generate each susceptibility metric of the plurality of susceptibility metrics, the one or more processors are further configured to apply the predictive ML model to information regarding one or more organizational characteristics of the individual.

Example 80. The one or more non-transitory computer-readable storage media of any one of examples 51 to 75, wherein to generate each susceptibility metric of the plurality of susceptibility metrics includes instructions that, when executed by one or more processors, cause the one or more processors to: apply the predictive ML model, trained on predictive ML training data, to one or more of (1) historical electronic message data indicating historical electronic message information for the individual, or (2) electronic message template characteristic data indicating characteristics of the plurality of electronic message templates.

Example 81. The one or more non-transitory computer-readable storage media of any one of examples 51 to 75, or example 80, wherein generating each susceptibility metric of the plurality of susceptibility metrics includes instructions that, when executed by one or more processors, cause the one or more processors to: apply the predictive ML model to information regarding one or more organizational characteristics of the individual.

What is claimed:

1. A computer-implemented method comprising:
generating, by one or more processors, a plurality of electronic message templates, at least by applying a generative machine learning (ML) model, trained on a corpus of electronic messages, to electronic message feature data indicating electronic message features;
generating, by the one or more processors, a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and
for each individual of the plurality of individuals,
selecting, by the one or more processors, a particular electronic message template of the plurality of electronic message templates, based at least upon the susceptibility metric generated for the individual and the particular electronic message template,
generating, by the one or more processors, a respective electronic message based upon the particular electronic message template, and
causing, by the one or more processors, the respective electronic message to be provided to a user device associated with the individual.

2. The computer-implemented method of claim 1, wherein generating the plurality of electronic message templates comprises:
generating topic data indicating at least one topic, at least by applying a topic ML model, trained on historical post data, to post data associated with a plurality of posts; and
generating the electronic message feature data using the topic data.

3. The computer-implemented method of claim 2, wherein the topic ML model includes a graph ML model.

4. The computer-implemented method of claim 1, wherein generating the plurality of electronic message templates comprises:
generating security inference data indicating at least one security inference, at least by applying a security inference ML model, trained on historical security intelligence data, to security intelligence data; and
generating the electronic message feature data using the security inference data.

5. The computer-implemented method of claim 1, wherein the electronic message features include one or more of a category, a subject, a sender, a level of urgency, a spelling error, a grammatical error, or an emotional trigger classification.

6. The computer-implemented method of claim 1, wherein generating each susceptibility metric of the plurality of susceptibility metrics includes applying the predictive ML model, trained on predictive ML training data, to one or more of (1) historical electronic message data indicating historical electronic message information for the individual, or (2) electronic message template characteristic data indicating characteristics of the plurality of electronic message templates.

7. The computer-implemented method of claim 1, wherein generating each susceptibility metric of the plurality of susceptibility metrics includes applying the predictive ML model to information regarding one or more organizational characteristics of the individual.

8. The computer-implemented method of claim 1, wherein the predictive ML model includes an XGBoost model.

9. The computer-implemented method of claim 1, wherein selecting the particular electronic message template for each individual includes using a rule-based algorithm, based upon one or more of a system access level of the individual, historical electronic message survey information of the individual, or historical electronic message campaign results of the individual.

10. The computer-implemented method of claim 1, further comprising:
for each individual of the plurality of individuals, monitoring, by the one or more processors, how the individual interacts with the respective electronic message.

11. The computer-implemented method of claim 10, wherein monitoring how each individual of the plurality of individuals interacts with the respective electronic message includes one or more of:
detecting an interaction, by the individual via the user device, with interactive content of the respective electronic message;
receiving a reply electronic message, from the individual via the user device, in response to the respective electronic message; or
receiving feedback, from the individual via the user device, associated with the respective electronic message.

12. A system comprising memory and one or more processors communicatively coupled to the memory, the one or more processors configured to:
generate a plurality of electronic message templates, at least by applying a generative machine learning (ML) model, trained on a corpus of electronic messages, to electronic message feature data indicating electronic message features;
generate a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and
for each individual of the plurality of individuals,
select a particular electronic message template of the plurality of electronic message templates, based at least upon the susceptibility metric associated with the individual and the particular electronic message template,
generate a respective electronic message based upon the particular electronic message template, and
cause the respective electronic message to be provided to a user device associated with the individual.

13. The system of claim 12, wherein the electronic message features include one or more of a category, a subject, a sender, a level of urgency, a spelling error, a grammatical error, or an emotional trigger classification.

14. The system of claim 12, wherein to generate each susceptibility metric of the plurality of susceptibility metrics, the one or more processors are further configured to:
apply the predictive ML model, trained on predictive ML training data, to one or more of (1) historical electronic message data indicating historical electronic message information of the organization for the individual, or (2) electronic message template characteristic data indicating characteristics of the plurality of electronic message templates.

15. The system of claim 12, wherein to generate each susceptibility metric of the plurality of susceptibility metrics, the one or more processors are further configured to apply the predictive ML model to information regarding one or more organizational characteristics of the individual.

16. The system of claim 12, the one or more processors are further configured to monitor how each individual of the plurality of individuals interacts with the respective electronic message.

17. The system of claim 16, wherein to monitor how each individual of the plurality of individuals interacts with the respective electronic message, the one or more processors are further configured to one or more of:
detect an interaction, by the individual via the user device, with interactive content of the respective electronic message;
receive a reply electronic message, from the individual via the user device, in response to the respective electronic message; or
receive feedback, from the individual via the user device, associated with the respective electronic message.

18. One or more non-transitory computer-readable storage media including instructions that, when executed by one or more processors, cause the one or more processors to:
generate a plurality of electronic message templates, at least by applying a generative machine learning (ML) model, trained on a corpus of electronic messages, to electronic message feature data indicating electronic message features;
generate a plurality of susceptibility metrics using a predictive ML model, wherein each susceptibility metric of the plurality of susceptibility metrics indicates a predicted probability of a respective individual, of a plurality of individuals, interacting with an electronic message generated using a respective electronic message template of the plurality of electronic message templates; and
for each individual of the plurality of individuals,
select a particular electronic message template of the plurality of electronic message templates, based at least upon the susceptibility metric associated with the individual and the particular electronic message template,
generate a respective electronic message based upon the particular electronic message template, and
cause the respective electronic message to be provided to a user device associated with the individual.

19. The one or more non-transitory computer-readable storage media of claim 18, wherein to generate each susceptibility metric of the plurality of susceptibility metrics includes instructions that, when executed by one or more processors, cause the one or more processors to:
apply the predictive ML model, trained on predictive ML training data, to one or more of (1) historical electronic message data indicating historical electronic message information for the individual, or (2) electronic message template characteristic data indicating characteristics of the plurality of electronic message templates.

20. The one or more non-transitory computer-readable storage media of claim 18, wherein to generate each susceptibility metric of the plurality of susceptibility metrics includes instructions that, when executed by one or more processors, cause the one or more processors to:
apply the predictive ML model to information regarding one or more organizational characteristics of the individual.
